(19) United States
(12) Patent Application Publication
(10) Pub. No.: US 2013/0028790 A1
(43) Pub. Date: Jan. 31, 2013

(54) OPTICS MODULE FOR DETERMINING AT LEAST ONE PHYSICAL OR CHEMICAL, PROCESS VARIABLE, ESPECIALLY CONCENTRATION OF AT LEAST ONE COMPONENT OF A MEDIUM

(71) Applicants: Ralf Bernhard, Stuttgart (DE); Rainer Morlok, Jettingen (DE)

(72) Inventors: Ralf Bernhard, Stuttgart (DE); Rainer Morlok, Jettingen (DE)

(73) Assignee: Endress + Hauser Conducta Gesellschaft für Mess- und Regeltechnik mbH + Co. KG, Gerlingen (DE)

(21) Appl. No.: 13/559,874

(22) Filed: Jul. 27, 2012

(30) Foreign Application Priority Data
Jul. 27, 2011 (DE) 10 2011 079 938.9

(51) Int. Cl. G01N 21/78; F21V 23/00; G01J 1/44

(52) U.S. Cl. 422/82.09; 250/206; 313/323

(57) ABSTRACT

An optics module for determining at least one physical or chemical, process variable, especially concentration of at least one component of a medium, comprising: at least one light source; at least one data memory, wherein at least one characteristic of the light source is stored in the data memory; at least one interface, wherein the interface is designed for data transmission and/or energy transmission; and a platform. The light source, the data memory and the interface are arranged on/in the platform.

The invention relates to an optics module for determining at least one physical or chemical, process variable, especially concentration of at least one component of a medium.

In an optical measuring system for determining at least one physical or chemical, process variable, radiation emitted by a light source forms, in given cases, with the assistance of optical elements, such as e.g. lenses, mirrors, beam splitters or optical fibers, a measuring beam or reference beam directed at least partially on an optical path through a flow through cell. In such case, an interaction between the radiation and the medium contained in the flow through cell occurs. The interaction is especially an absorption or scattering.

In the following, by way of example, scattering for determining turbidity as well as absorption for determining concentration of a medium will be discussed. Of course, the fundamental principles of the invention can also be applied with other optical measuring methods in analysis, especially in process measurements technology, in which ascertainable changes of an optical transmitter signal result from the influence of the medium.

In the case of scattering, scattered light is detected at a specific angle, for example, 90°, to the irradiation direction. The turbidity of the medium can be extrapolated from the intensity of the measured scattered light. Turbidity arises in gases or liquids through the presence of dispersed materials.

In the case of absorption, at least one part of the radiation, e.g. that in a certain wavelength range, is absorbed by the medium. The absorption by a medium depends on the material composition and the concentration. After passing through the flow through cell, the radiation, which is changed by the absorption, falls on a radiation detector, which outputs a measurement signal dependent on the intensity of the incoming radiation. The absorption/transmission/reflection by the medium and thus the type and/or composition of the medium, especially the concentration of an analyte in the medium, can be deduced from the measurement signal.

In the case of photometry, absorption is measured with the assistance of light. If one radiates the solution of an absorbing medium with light, the absorption depends on the spectral properties of the medium, the concentration and the length of the light path in the solution. Photometry permits qualitative and quantitative detection as well as the tracking of the dynamics of chemical processes of radiation absorbing, chemical compounds.

In the case of colorimetry, which is related to photometry, either (in the case of colored media) the color intensity of a sample is directly measured by optical comparison, or the medium, after transformation into a colored reaction product by a chemical reaction, is measured with the assistance of a suitable comparison scale. In the measurement, the color density of the substance to be measured is directly determined with the comparison scale. In the case of color equality, the concentration of the medium corresponds to the value imprinted on the scale or to the corresponding value in a table. With colorimetry, the concentration of components in colloidal solutions and suspensions can also be determined. In spectral photometry, the photometry is operated with different wavelengths, i.e. either broadband radiators and receivers or a number of (different) narrowband radiators and receivers are necessary.

With photometric methods in process measurements technology, for example, in monitoring water in pipelines, gutters and/or clarification plants, the content of various ions, such as e.g. aluminum ions, ammonium ions, calcium ions, chromium ions, iron ions, or manganese ions, the content of chloride, nitrate, nitrite, phosphate, silicate and sulfide, as well as of organic compounds, such as e.g. hydrazine can be determined. Also, the hardness of an aqueous solution can be ascertained photometrically.

“Light” in the sense of this invention should not be limited to the visible range of the electromagnetic spectrum, but rather understood as electromagnetic radiation of any wavelength, especially also radiation in the far ultraviolet (UV) and infrared (IR) wavelength ranges.

For photometric detection, some media show suitable characteristic absorption bands in the far UV region, thus especially between 200 and 300 nm. For example, the concentration of nitrate is registered based on absorption of a wavelength of 214 nm by the measured liquid. In the far UV region, a further photometrically ascertained parameter, which is specially used in the field of water quality monitoring, is the spectral absorption coefficient (SAC) at 254 nm. The SAC at 254 nm serves for the detection of the presence of dissolved organic ingredients.

In known optical measuring systems, depending on the substance to be measured, either a broadband radiator (e.g. an incandescent light bulb) is applied, or, most often, a narrow band radiator (e.g. a light emitting diode (LED)). In such case, the LED is used for producing a measuring light lying in a suitable wavelength range. The intensity of the light emitted by the light emitting diode corresponds to the transmission signal strength. Correspondingly, a photodiode, which produces a receiver signal, for example, a photocurrent or a photovoltage, from the received light, can be applied as a receiver. The receiver signal strength depends on the intensity of the light intensity incoming on the receiver diode, thus in the case of turbidity measurement, on the intensity of the scattered light. In turn, this correlates directly with the particle size and concentration of the scattering, dispersed materials, thus the turbidity of the measured medium. In the case of concentration measurement, the intensity depends on the transmission characteristics of the medium to be measured.

Problematic in the case of LEDs are the, at times, significant individual variations of the optical parameters, such as e.g. radiated power. The differences are yet greater in comparing LEDs from different manufacturers. Moreover, LEDs have relatively short product life cycles. Thus, it cannot be assured that a specific type of LED will be still available on the market a few years hence.

Regardless of the type of light source used, the spectral properties of the source enter into the measurement. Because of this, a calibrating of the measuring system, especially of the light source, is absolutely necessary, in order to assure reliable measurement. With a calibration, the spectral properties of the source can be removed from the measurement result, so that the result is independent of the individual properties of the light source. In given cases, process flow must be interrupted for the duration of the calibrating. Thus, one strives to perform the calibrating as infrequently as possible and as quickly as possible, in order to minimize the process down time. With each replacement of the light source, a renewed calibrating is necessary, which affects productivity negatively.

Consequently, an object of the invention is to provide a system, which permits replacement of the light source without requiring renewed calibration.

The object is achieved by an optics module, comprising:
at least one light source;
at least one data memory,
wherein at least one characteristic of the light source is stored in the data memory;
at least one interface,
wherein the interface is designed for data transmission and/or energy transmission; and
a platform,
wherein the light source, the data memory and the interface are arranged on/in the platform.

By storing at least one characteristic of the light source, calibrating on-site is no longer necessary, and the calibration effort is lessened. In this way, maintenance time is shortened, and down time of the plant is minimized. In this way, costs and resources can be saved. Moreover, the dependencies on component specifications are lessened and quality of the total measuring system, in spite of different component specifications, can be kept high.

In an advantageous embodiment, the light source is an LED. An LED sends a very specific wavelength and can be selected as a function of the analyte. Wavelengths for most required analytes are available. LEDs consume relatively little energy, are small and integratable, whereby costs can be saved.

In a preferred embodiment, at least one optical characteristic of the light source is stored in the data memory, wherein the optical characteristic is the (central) wavelength, bandwidth, radiation characteristic, color temperature, radiated power, spectrum and/or color rendering index.

In an advantageous form of embodiment, at least one electrical characteristic is stored in the data memory, wherein the electrical characteristic is the turn-on voltage, driving frequency, on/off time, power consumption, efficiency and/or driving current.

The general information at least stored in the data memory is preferably the serial number, the date of manufacture, etc.

In a preferred embodiment, at least operating data are stored in the data memory, wherein the operating data are calibration data, operating hours, temperature loading, device data, process data, historical data.

Of course, the said lists above are not complete and any type of information can be stored in the data memory. It is conceivable, depending on customer and/or customer request, that other data and information are stored in the memory.

Through the properties stored in the data memory, a calibration is no longer necessary on-site, when a replacement of the light source occurs. All data required for a continuous, reliable and correct measurement are secured in the data memory and are read out. An option is that the required properties are ascertained earlier in the laboratory and stored in the data memory. The data can be directly held in the data memory or a calibration model is created, which contains all required information. After exchange of the light source, the calibration model, which contains all data required for a correct measurement and was created in the laboratory, can be relied on and a calibration on-site is unnecessary.

Preferably, the data memory is a non-volatile memory. In this way, the stored data are maintained long term, especially also when no electrical current supply is connected.

In an advantageous arrangement of the optics module, at least one optical detector element is provided. The detector element is associated with the light source in a manner such that a light signal emitted by the light source is at least partially received by the detector element after an interaction with the medium, for example, after a scattering. Thus, the received intensity is a measure for a specific chemical or physical process variable, e.g. the turbidity of a medium.

In a preferred embodiment, at least one optical detector element is provided on an external module, wherein thereon at least one interface designed for data transmission and/or energy transmission is provided, wherein the external module is connected to the optics module via the interfaces.

If a detector element is located on an external module, it can be arranged, for example, with the optics module, on or in a pipe, container, cuvette, etc. Light transmitted from the light source is then at least partially detected by the detector element after interaction with the medium located in the pipe, container, cuvette, etc. The external module is connected to the optics module via an interface.

In an advantageous form of embodiment, at least one superordinated unit is provided on the optics module and/or the external module, wherein the superordinated unit performs at least one of the following functions:
checking, open-loop controlling and/or closed-loop controlling of the light source,
writing to and/or reading from the data memory,
checking, open-loop controlling and/or closed-loop controlling of the detector element,
storing data,
processing and/or forwarding signals measured by the detector element.

Through the at least one superordinated unit, in general, an “intelligent agent”, such as a microprocessor or an FPGA, the light source can be controlled, and measurement data can be processed, stored and dispatched, for example. In this way, complex tasks can also be managed directly “on-site”, whereby the transmission of raw data can be avoided and transmission safety is increased.

The invention will now be explained in greater detail based on the drawing, the figures of which show as follows:

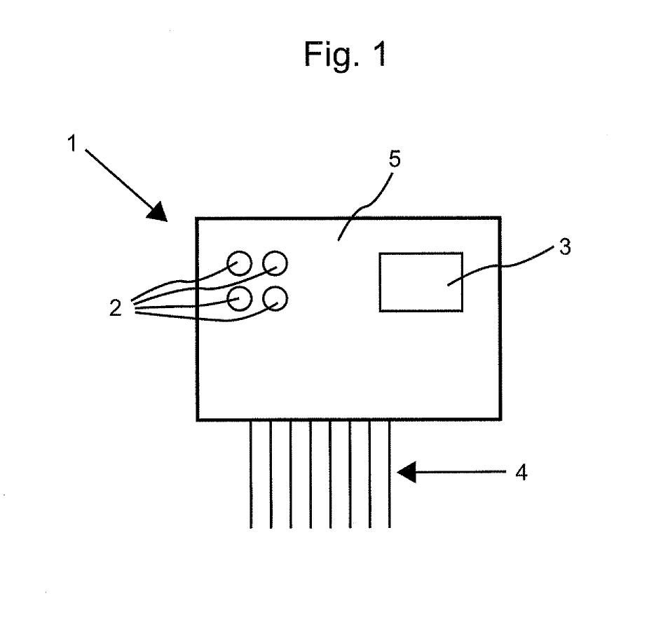

FIG. 1 an optics module of the invention;

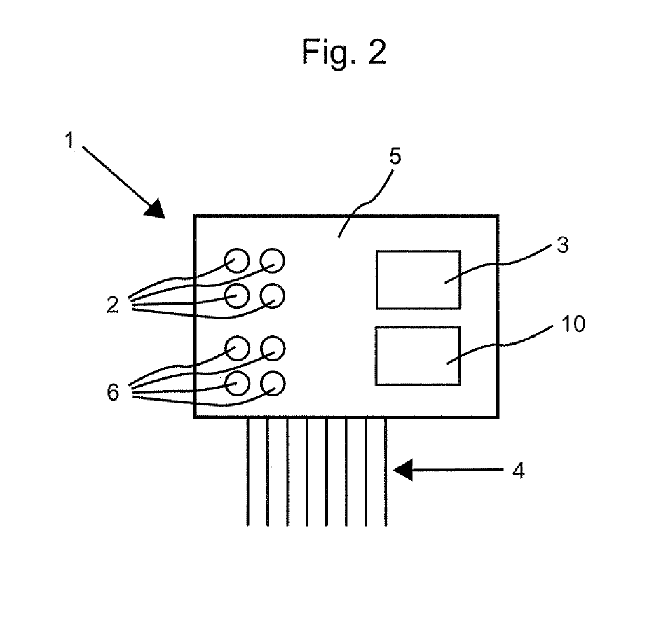

FIG. 2 an optics module of the invention in a further embodiment; and

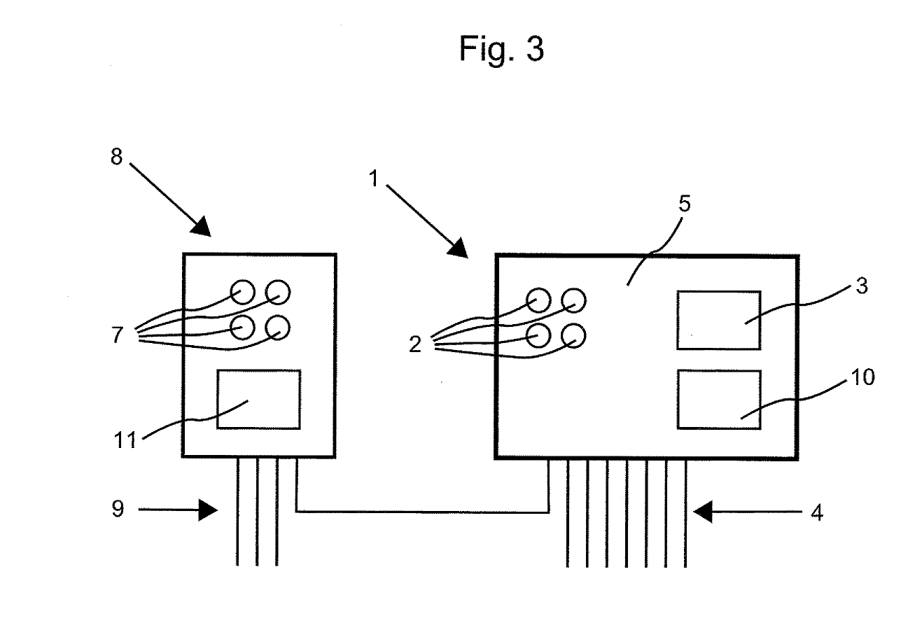

FIG. 3 an optics module of the invention in an additional embodiment, with an external module.

In the figures, equal features are marked with equal reference characters.

FIG. 1 shows an optics module of the invention, which in its totality is marked with the reference character 1. Optics module 1 comprises at least one light source 2, a data memory 3 and an interface 4. The said components are arranged on a platform 5.

Platform 5 is typically a printed circuit board (PCB) and comprises an electrically insulating material, most often a fiber reinforced synthetic material, such as FR-4. It is conceivable however, that light source 2, data memory 3 and interface 4 are arranged on/in a (shared) housing as platform. Thus, for example, interface 4 can be directly arranged in the corresponding openings of the housing.

Light source 2 comprises at least one LED, wherein both different LEDs can be used, as well as LEDs can be redundantly arranged on platform 5. Especially, LEDs of different wavelengths can be placed on/in platform 5.

Data memory 3 is typically a non-volatile memory, such as, for example, an EPROM, EEPROM or flash memory. The following information can be stored in data memory 3: optical, electrical, general and/or operating information.

Examples of optical information of light source 2 are the (central) wavelength, bandwidth, radiation characteristic, color temperature, radiated power, the spectrum and the color rendering index. Examples of electrical properties are the turn-on voltage, driving frequency, on/off time, power consumption, efficiency and driving current. Examples of general information are the serial number or date of manufacture. Examples of operating data are the calibration data, operating hours, temperature loading, device data, process data or historical data.

Of course, the above lists are not complete and any type of information can be stored in data memory 3. It is conceivable that other data and information are stored in the memory depending on customer and/or customer request.

Platform 5 having the said components can communicate with the “outside world” via interface 4. In this embodiment, light source 2 is controlled “externally” and the memory is written or read from the exterior. Interface 4 is embodied as a galvanic interface, i.e., for example, as a plug possibly having a cable. A variant is also conceivable, in which interface 4 is embodied as a galvanically decoupled interface (i.e. optical, capacitive, inductive).

If required, the components are connected electrically to one another. Thus, for example, both light source 2 as well as data memory 3 have a connection (not shown) to interface 4.

After mounting the components, light source 2, data memory 3 and interface 4, on platform 5, the properties of light source can be ascertained. Thus, for example, these optical properties include radiated power or radiated energy (see above), which are ascertained by corresponding measuring devices. It is conceivable that the measurements take place in a laboratory environment.

The ascertained properties are either directly stored in data memory 3 and/or the ascertained properties serve to create a suitable calibration model. If the optics module is later replaced, an “on-site” calibrating need no longer be performed, since all information is present in data memory 3 and can be read out. All properties required for the measurement, e.g. the concentration or the turbidity, and features of the light source, are contained in the calibration model and are stored in data memory 3.

A replacement of optics module 1 can occur because one of the components is defective or because an expansion of the functional scope is desired, for instance to include other wavelengths. Thus, the scope of service of optics module 1, and, thus, of the whole measuring system, can also be expanded.

FIG. 2 shows an embodiment, of optics module 1, wherein, in addition to the components described in FIG. 1, at least one detector element 6 and a superordinated unit 10 are located on platform 5.

Detector element 6 can be, in such case, a photodiode, a photodiode array, a CCD camera or some other optoelectronic apparatus. Generally, detector element 6 is able to output a measurement signal (most often, electrical) dependent on the intensity of the incoming radiation. Detector element 6 is associated with light source 2 in such a manner that a light signal emitted by light source 2, after interaction with the medium, for example, after scattering, is at least partially received and converted into an electrical signal, especially a photocurrent or a photovoltage, by detector element 6.

Superordinated unit 10 can be, for example, a microprocessor or a field programmable gate array (FPGA). Through this type of “intelligence”, the measurement signal output by detector element 6 can be received and processed, in order to ascertain specific physical or chemical, process variables, such as the concentration of a component or the turbidity of a medium. Also the data, in given cases processed data, can be stored in data memory 3 or forwarded via interface 4.

It is conceivable that a number of light sources 2 and detector elements 6 are used, wherein at least one light source-detector element pair is used as a reference element.

Another option is a variant, in which no superordinated unit 10 is present, i.e. optics module 1 comprises the components: platform 5, light source 2, data memory 3, interface 4 and detector element 6.

Moreover, an embodiment comprising the components, light source 2, data memory 3, interface 4 and superordinated unit 10, mounted on/in platform 5 forms another option.

FIG. 3 shows, supplementally to the already described components, an external module 8 comprising at least one detector element 7, a superordinated unit 11 and an interface 9. External module 8 is connected to optics module 1 via interfaces 4, 9.

Detector element 7 on external module 8 can possess the same properties as detector element 6 on optics module 1. Detector element 7 is associated with light source 2 in such a manner that a light signal emitted by light source 2, after interaction with the medium, is at least partially received and converted into an electrical signal, especially a photocurrent or a photovoltage, by detector element 7. It is conceivable that optics module 1 and external, module 8 are arranged on or in a pipe, container, cuvette, etc., and a medium located therein is examined by the described components.

Superordinated units 10, 11 can receive and process the measurement signal output by detector element 7, in order to ascertain specific physical or chemical, process variables, such as concentration of a component or turbidity of a medium. Also the data, possibly processed further, can be stored in data memory 3 or dispatched via one of interfaces 4, 9. Superordinated units 10, 11 can communicate with one another via a suitable protocol.

Another option is a form of embodiment, in which only one superordinated unit is arranged either on external module 8 or optics module 1. Moreover, an additional memory can also be placed on external module 8, or the superordinated unit itself can have a memory.

### LIST OF REFERENCE CHARACTERS

1 optics module
2 light source
3 data memory
4 interface of 1
5 platform
6 detector element of 1
7 detector element of 8
8 external module
9 interface of 8
10 superordinated unit of 1
11 superordinated unit of 8

1-10. (canceled)

11. An optics module for determining at least one physical or chemical, process variable, especially concentration of at least one component of a medium, comprising:
at least one light source;
at least one data memory, said at least one characteristic of said at least one light source is stored in said at least one data memory;
at least one interface, said at least one interface is designed for data transmission and/or energy transmission; and
a platform, wherein:
said at least one light source, said at least one data memory and said at least one interface are arranged on/in said platform.

12. The optics module as claimed in claim 11, wherein:
said at least one light source is an LED.

13. The optics module as claimed in claim 11, wherein:
at least one optical characteristic of said at least one light source is stored in said at least one data memory;
said optical characteristic is the (central) wavelength, bandwidth, radiation characteristic, color temperature, radiated power, spectrum and/or color rendering index.

14. The optics module as claimed in claim 11, wherein:
at least one electrical characteristic is stored in said at least one data memory;
said at least one electrical characteristic is the turn-on voltage, driving frequency, on/off time, power consumption, efficiency and/or driving current.

15. The optics module as claimed in claim 11, wherein:
at least one general piece of information is stored in said at least one data memory;
said general piece of information is the serial number, date of manufacture, etc.

16. The optics module as claimed in claim 11, wherein:
at least operating data are stored in said at least one data memory;
said operating data are calibration data, operating hours, temperature loading, device data, process data, or historical data.

17. The optics module as claimed in claim 11, wherein:
said at least one data memory is a non-volatile memory.

18. The optics module as claimed in claim 11, further comprising:
at least one optical detector element.

19. The optics module as claimed in claim 11, further comprising:
at least one optical detector element provided on an external module; and
at least one interface, which is designed for data transmission and/or energy transmission, provided on said external module; wherein:
said external module is connected to the optics module via said interfaces.

20. The optics module as claimed in claim 18, further comprising:
at least one superordinated unit is provided on the optics module and/or said external module, wherein:
said superordinated unit performs at least one of the following functions:
checking, open-loop controlling and/or closed-loop controlling of said at least one light source;
writing to and/or reading out from said at least one data memory;
checking, open-loop controlling and/or closed-loop controlling of said detector element;
storing data; and
processing and/or forwarding signals measured by said detector element.
